(19) United States
(12) Patent Application Publication
(10) Pub. No.: US 2014/0157123 A1
(43) Pub. Date: Jun. 5, 2014

(54) METHOD AND SYSTEM FOR A PERSONAL CHANNEL ON A MULTIMEDIA DEVICE

(71) Applicant: THOMSON LICENSING, Issy de Moulineaux (FR)

(72) Inventor: Stephane Haziza, Woodland Hills, CA (US)

(73) Assignee: THOMSON LICENSING, Issy de Moulineaux (FR)

(21) Appl. No.: 13/691,019

(22) Filed: Nov. 30, 2012

(51) Int. Cl. G06F 3/0484

(52) U.S. Cl. CPC G06F 3/0484
USPC 715/716

(57) ABSTRACT

The disclosed embodiments relate to a system and method for a personal channel on a multimedia device. The method includes scheduling a time period for providing media content from a device to generate a personal channel. The method also includes selecting the personal channel at a time approximate to the scheduled time period. Additionally, the method includes providing the media content during the scheduled time period.

### FIELD OF THE INVENTION

The present invention involves operating a multimedia device. More specifically, the present invention relates to a system for operating a personal channel on a multimedia device.

### BACKGROUND OF THE INVENTION

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Home theater and entertainment systems provide content from numerous sources, including, but not limited to, cable, satellite, Internet service providers, and various multimedia devices. Multimedia devices may play movies, video game, or other multimedia experiences over a television. Such devices may include, but are not limited to, set-top boxes, streaming devices, smartphones, desktop computers, laptops, high-definition video disc players, and so on.

In many systems, controls and menus for selecting the various content choices may be tedious. For example, a user is attempting to watch a movie online. The user first locates an appropriate remote control for the device, for example, a television remote. Then, the user may select a new input to supply the preferred content to play over the television. Then, the user may locate another remote control to access the new input device. Then, the user may navigate additional menus and selections for the specific content. In addition to the tedious menu entries, an inadvertent press of one or more keys while selecting a movie, or other entertainment, may set the user one or more steps back, forcing the repetition of some steps.

An improved system or method for presenting personalized content on a multimedia device is desirable.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for a personal channel on a multimedia device. More specifically, there is provided a method to generate a personal channel. The method includes scheduling a time period for providing media content from a device. The personal channel is selected at a time approximate to the scheduled time period. The media content is provided during the scheduled time period on the personal channel.

### BRIEF DESCRIPTION OF THE DRAWINGS

Advantages of the invention may become apparent upon reading the following detailed description and upon reference to the drawings in which:

FIG. 1 is a simplified block diagram of an exemplary system in accordance with one embodiment of the present invention;

FIG. 2 is a simplified block diagram of an exemplary menu interface in accordance with one embodiment of the present invention;

FIG. 3 is an exemplary interface in accordance with one embodiment of the present invention;

FIG. 4 is a flow chart illustrating an exemplary method for a multimedia device with in accordance with embodiments of the present invention; and

FIG. 5 is a simplified block diagram of an exemplary system in accordance with one embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

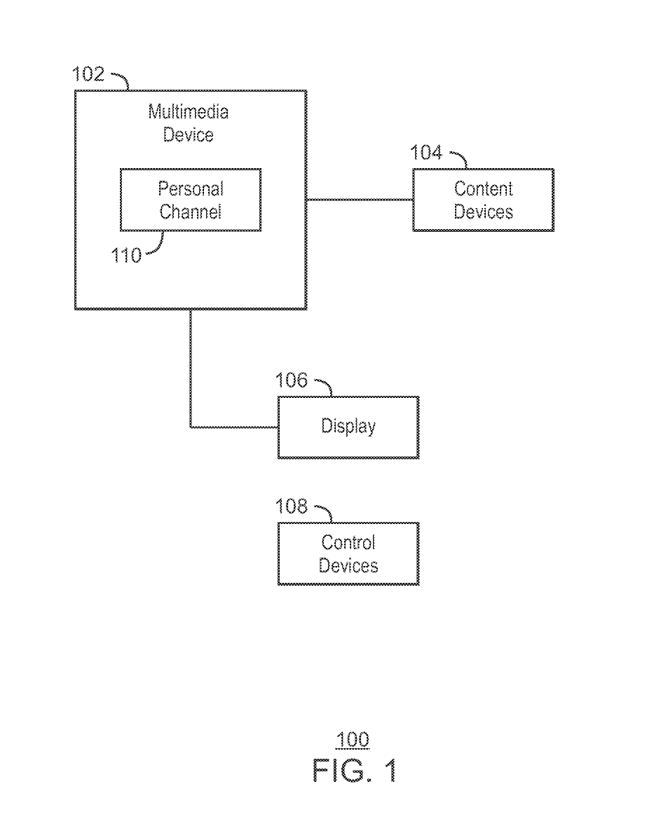

FIG. 1 is a simplified block diagram of an exemplary system 100 in accordance with one embodiment of the present invention. Being exemplary, the system 100 represents physical embodiments of a multimedia device 102, content devices 104, and display 106, operable in accordance with the principles of the present invention. The multimedia device 102 may be connected to content devices 104, and the display 106. The multimedia and content devices 102, 104 process multimedia signals, and may include, but not be limited to a set top box device for cable, satellite, or internet protocol television, digital video recorder (DVR), digital video disc (DVD) player, high-definition (HD) disc player, streaming device, and the like. One or more control devices 108 may be used to operate one or more of the devices 102, 104 and the display 106. The control devices 108 may include remote controls, computing devices controls, a control panel on the device 102, 104 or display 106, and so on.

The multimedia device 102 may be connected, or otherwise coupled to, the content devices 104 over a bus, such as a universal serial bus. In one embodiment, the content devices 104 are connected over a network, including but not limited to a local area network, or a wide area network, such as the Internet. Such networks may be wireless. Additionally, content devices 104 may also include computing devices, such as smartphones, desktop computers, laptops, tablets, servers, and so on.

The multimedia device 102 provides one or more personal channels 110. Each personal channel 110 is a schedule of content media, such as movies, personal videos, pay per view events (PPV), games, or other content provided by any of devices 102, 104. Through selections over the control device 110, a user schedules various content from among devices 102, 104 for interaction, e.g., viewing, at the user's selected times. Then, at a time approximate to the time of scheduled content, the user may select their personal channel 110 on the multimedia device 102, to view their content, play their game, and the like.

The content devices 104 may also include displays, speakers, and so on, for presenting content. In one embodiment, such devices 104 may also present, e.g., display, the content from the personal channel 110. In such an embodiment, the user may authorize specific content devices 104 to play the personal channel 110.

Additionally, the user may also specify whether individual content from the user's personal channel 110 is displayed merely on the user's personal channel 110, or on a number of other personal channels 110.

The personal channel 110 is selected with the control device 108. The control device 108 may include a specified key (not shown) for selecting the personal channel 110. Alternatively, the personal channel 110 may be selected using a specified code, e.g., a 3-digit number. Advantageously, by using the personal channel 110, the user may view, or interact with their content at a specific time, instead of looking for a remote, or tediously paging through various menus to select the content.

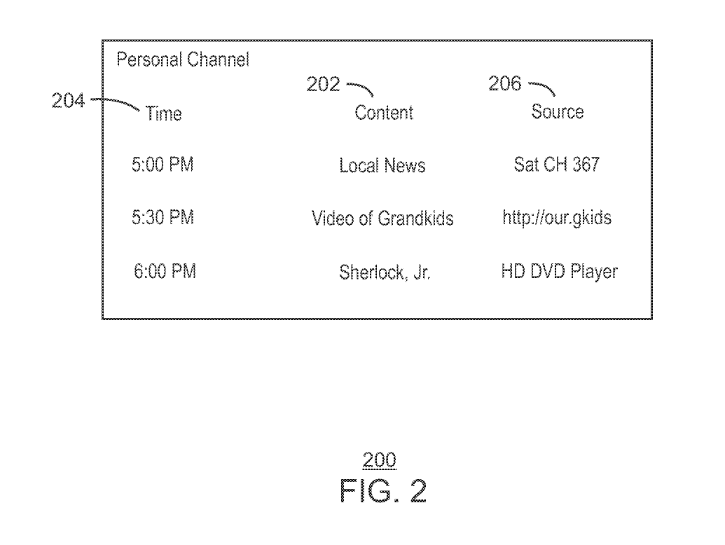

FIG. 2 is a simplified block diagram of an exemplary menu interface 200 in accordance with one embodiment of the present invention. The menu interface 200 enables the user to create and update their personal channel 110. The menu interface 200 includes content entries 202 for specific times 204, and the source 206. For example, on this user's personal channel, starting at 5:30 in the evening, the user can watch the local news on satellite (sat) channel 367. At 6:00, video of the grandkids can be viewed at the given Internet address. At 6:30, the HD DVD player plays the movie, “Sherlock, Jr.”

Because the personal channel 110 provides scheduling capability, the user may also place messages to be played at a specified time. The user may enter messages through an interface that includes an auto-completion mechanism, to aid the user's message entry. Sample messages may include reminders, appointments, and other typical entries for calendar software. Each message may also be customized to include voice, music, video, and so on. In one embodiment, the user may select a portion of video to accompany such messages, like a scene from a favorite movie. As an example, a birthday message is presented on the display 106 with a selected music video. Another example message could be a to-do list for the day, with sound effects, like a dog's bark to remind you to pick up the dog.

The user may have a pre-defined profile that specifies personal data, such as name, birth date, and a code for playing the personal channel. In one embodiment, the multimedia device 102 may pause, or otherwise place active content 202 in a standby mode while a message is presented to the user. The user is given an option to resume the content 202 after the message is delivered.

In one embodiment, messages saved to the personal channel 110 may be retrieved using a web interface, e.g., a specific web-site managed by a broadcaster that provides the multimedia device 102 for the user. Alternatively, such messages may be prepared and sent for a specific customer, upon verification of a credential, through specific Entitlement Management Messages or Common Alerting Protocol (CAP).

Additionally, the personal channel 110 may connect and synchronize to other calendar software, and import selected events from content devices 104 over, e.g., USB connectivity with a connected cradle. Imported events may include .ics or .pst files. This may enable the capture of complex text for calendar entries in the personal channel 110.

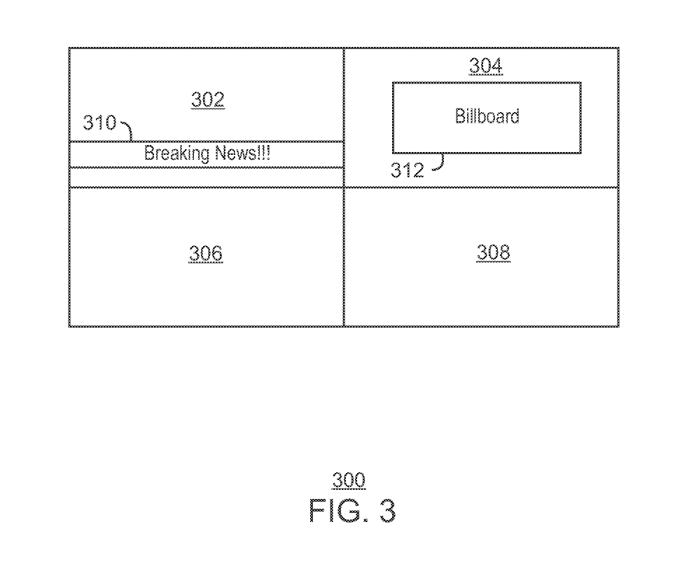

FIG. 3 is an exemplary personal channel interface 300 in accordance with one embodiment of the present invention. While the personal channel 110 may include a single screen, in one embodiment, the personal channel interface 300 may include multiple screens that equally partition each part of the display 106, e.g., 2 screens on either half of a display. The interface 300 includes 4 screens 302, 304, 306, 308, each on one quarter of the display 106. Alternatively, each of these screens 302, 304, 306, 308 may be shown on multiple displays 106. Additionally, the user may rotate each screen 302, 304, 306, 308 in 90 degree increments.

Each screen 302, 304, 306, 308 provides content 202 from the personal channel 110. In one embodiment, the personal channel 110 may include a banner 310. The banner 310 presents a feed, such as closed caption feed from a broadcaster, really simple syndicate (RSS) feed, and the like. Alternatively, the banner may present messages, downloadable local coupons, calendar events, or even content from a content device 104.

Screen 304 includes a billboard 312, which may be an on-screen display with local advertisements, coupons that can be directly downloaded to a device connected to the multimedia device 102. The billboard 312 may be overlaid on the current content. Additionally, the current content may be placed in standby while the billboard 312 is displayed. The user may request the billboard 312 by pressing a specific key on the control device 108.

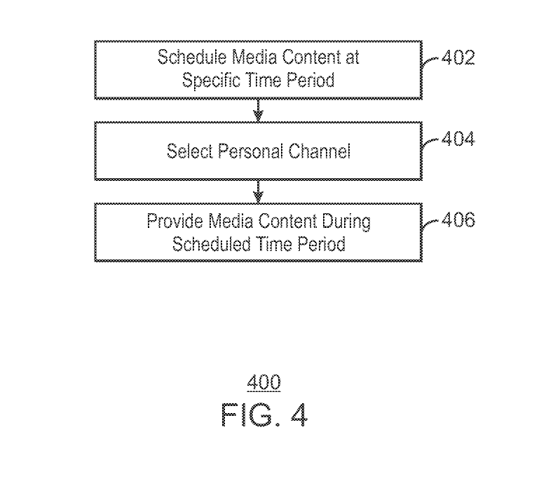

FIG. 4 is a flow chart illustrating an exemplary method 400 for a multimedia device in accordance with embodiments of the present invention. At block 402, the user schedules a time period for content from a device to be provided via the multimedia device 122. At block 404, the user selects the personal channel 110 at a time approximate to the scheduled time period. At block 406, the multimedia device 102 provides the content during the time period.

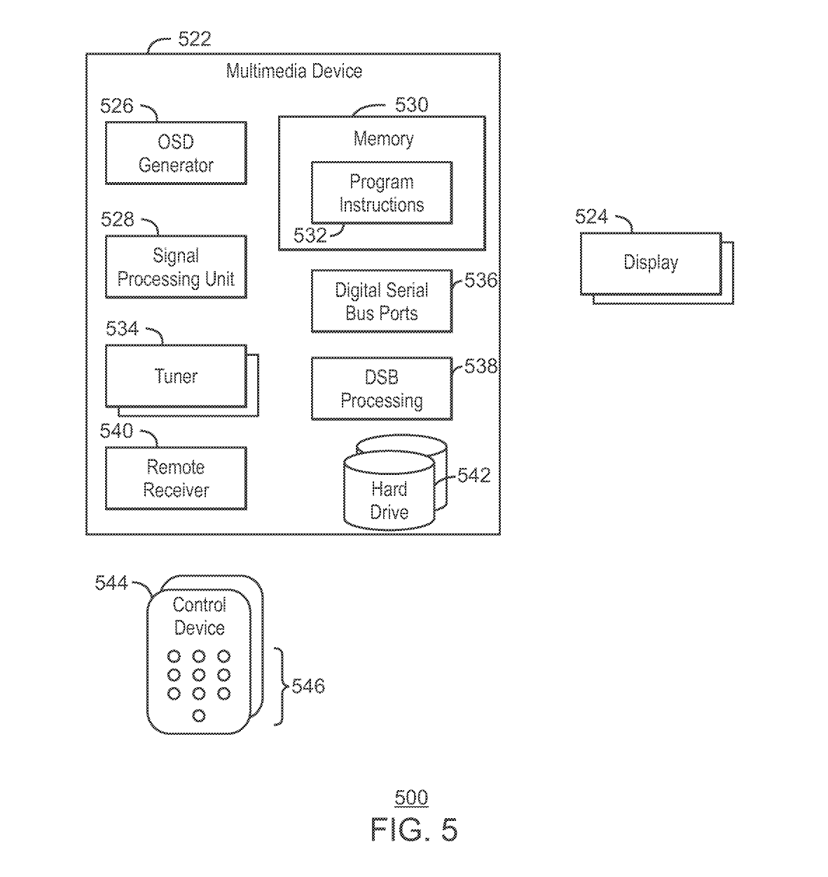

FIG. 5 is a simplified block diagram of an exemplary system 500 in accordance with one embodiment of the present invention. Being exemplary, the system 500 represents physical embodiments of a multimedia device 522 and display 524, operable in accordance with the principles of the present invention. The multimedia device 522 may be a device for processing multimedia signals, such as a set top box device, digital video recorder, digital video disc (DVD) player, high-definition (HD) disc player, streaming device, and the like. The multimedia device 522 may be connected, or otherwise coupled to, the display 524.

Alternatively, in an example system 500, the multimedia device 522 may be a television, which includes the display 524. The display 524 may include speakers (not shown). The speakers may be connected, or otherwise coupled to, the display 524 or the multimedia device 522. The multimedia device 522 may provide basic functionality and features consistent with a typical television apparatus, as well as the present functionality described herein.

The multimedia device 522 is operable, configured or adapted to process digital television signals, digital audio/video (A/V) content and the like (collectively, digital content), as well as analog television signals and analog NV content and the like (collectively, analog content) from various input sources available for the multimedia device 522. It is noted, however, that the multimedia device 522 may process digital content. The various input sources may include A/V signals from a satellite or cable provider, tunable digital content, DVDs, HD video and audio content, and the like. In one embodiment, the source may be a server that streams content over a local area network or a wide area network, such as the Internet.

The multimedia device 522 includes an on-screen display (OSD) generator 526 that is operable to provide the graphics, text and the like for on-screen menus on the display 524. The display 524 is further operable to display menus or user selectable options for programming a personal channel. The menus or options may be displayed in response to user input, television system signals, signals from components, and may accept user input for selection of various options.

The multimedia device 522 may include a television signal processing unit 528 that is operable, configured, or adapted to process digital television signals, such as MPEG2 digital signals. The television signal processing unit 528 may also provide analog television signal processing, if the multimedia device 522 supports analog television signals. The television signal processing unit 528 also provides control of the various television apparatus components, features and functions of the multimedia device 522, and the like. The multimedia device 522 further includes memory 530 storing program instructions 532. The program instructions 532 are used by the multimedia device 522 (i.e. the television signal processing unit 528 and digital serial bus processing (DSB) unit 538) for operation of the multimedia device 522 in accordance with the present principles.

The multimedia device 522 may include one or more tuners 534 operable to receive tunable digital content. Additionally, the multimedia device 522 may include digital serial bus ports 536 for connection and communication with one or more DSB-compliant devices or components. The digital serial bus compliant devices or components may be a digital recording device having a hard disk drive, a DSB box, or the like. In an example embodiment, the digital serial bus is an IEEE 1394 digital serial bus and the components connected to the DSB ports 536 are IEEE 1394 compliant devices. In such an embodiment, the DSB processing unit 538 performs IEEE 1394 processing. In this way, the multimedia device 522 provides for recording functionality over the IEEE 1394 bus by establishing a connection between an IEEE 1394 compliant recordable device and an IEEE 1394 compliant recording device. Additionally, the multimedia device 522 may include one or more hard drives 542

The multimedia device 522 may accept user input via a control device 544 with various buttons 546 for operating the multimedia device 522. The control device 544 sends user-initiated input signals to a receiver 540. The control device 544 may include, but not limited to, be, for example, a panel on a set top box.

In one embodiment, the control device 544 is a remote controller. In such an embodiment, the remote controller and the receiver 540 may use infrared (IR), radio frequency (RF), or other transmission means. In an example embodiment, the display 524 also includes a remote receiver (not shown).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method for a multimedia device, comprising:
scheduling a time period for providing media content from a device to generate a personal channel;
selecting the personal channel at a time approximate to the scheduled time period; and
providing the media content during the scheduled time period.

2. The method of claim 1, comprising playing the media content.

3. The method of claim 2, comprising associating a text feed with the media content, wherein the text feed comprises a really simple syndicate (RSS) feed.

4. The method of claim 3, comprising presenting a banner in association with the media content, wherein the banner comprises the text feed.

5. The method of claim 2, comprising presenting a billboard in association with the media content, wherein the billboard comprises a downloadable coupon.

6. The method of claim 1, comprising:
scheduling a plurality of media content for the time period; and
playing the media content, and the plurality of media content in equal distribution on a display.

7. The method of claim 6, comprising playing the plurality of media content on a plurality of devices connected to the multimedia device.

8. The method of claim 1, wherein the device comprises the multimedia device.

9. The method of claim 1, comprising playing the media content on a device connected to the multimedia device.

10. The method of claim 1, comprising rotating the displayed media content 90 degrees in response to a user request.

11. A multimedia device configured to:
schedule a plurality of time periods for providing a plurality of media content from a plurality of devices to generate a personal channel;
select the personal channel at a time approximate to one of the scheduled time periods;
provide media content scheduled during the time;
play the media content;
associate a text feed with the media content; and
present a banner in association with the media content, wherein the banner comprises the text feed.

12. The multimedia device of claim 11, wherein the text feed comprises a closed caption feed from a broadcaster.

13. The multimedia device of claim 11, wherein the text feed comprises one or more messages associated with one or more time periods during which the personal channel is playing the media content.

14. The multimedia device of claim 11, configured to present a billboard in association with the media content, wherein the billboard comprises an advertisement.

15. The multimedia device of claim 11, configured to present media content successively from an Internet address, a portable computing device, and the multimedia device, in response to a selection of the personal channel.
